(19) United States
(12) Patent Application Publication
(10) Pub. No.: US 2024/0147266 A1
(43) Pub. Date: May 2, 2024

(54) CUSTOMIZABLE AGENT DESKTOP FOR INTERNET OF THINGS DEVICE AND CELLULAR NETWORK CONNECTIVITY DATA

(71) Applicant: Twilio Inc., San Francisco, CA (US)

(72) Inventors: Tobias Peter Goebel, Melrose, MA (US); Brian Jay Mgrdichian, Lakewood, CO (US)

(21) Appl. No.: 17/976,015

(22) Filed: Oct. 28, 2022

(51) Int. Cl. H04W 24/04; H04W 24/10; H04W 36/00

(52) U.S. Cl. CPC H04W 24/04; H04W 24/10; H04W 36/0083

(57) ABSTRACT

Methods, systems, and computer programs are presented for programmatically controlling an Internet of Things (IoT) device in real-time based on network status. In response to an API request or by accessing data previously pushed to a database, data related to a network and the IoT device is received. An aggregation of the data related to the network is generated and presented to the user. The aggregation indicates whether a problem related to operability of the IoT device is related to a problem with the network.

### TECHNICAL FIELD

The subject matter disclosed herein generally relates to methods, systems, and machine-readable storage media for programmatically accessing and/or configuring Internet of Things (IoT) devices and, in one specific example, to techniques for automatically invoking one or more functions of an IoT device of a customer based on a detection that a problem with a network to which the IoT device is connected is not related to a problem with the network itself.

### BACKGROUND

When call centers are serving a client, a large amount of information, including network status, has to be sifted through by the agent to determine the cause of the problem. Often, multiple windows would be open, each containing only a fraction of the information needed to monitor, diagnose, and/or address problems with Internet of Things (IoT) devices.

Contact centers have agent operators that provide support to clients. These agents may often use multiple tools, programs, and applications to provide service to the customer. For example, they may have programs open that provide information on a particular customer, including information concerning one or more problems that the customer has reported with respect to one or more IoT devices of the customer, and different programs open that provide information pertaining to the one or more IoT devices.

These different tools do not communicate with each other and are cumbersome for an agent to navigate in real-time, such as when the agent is engaged in a communication with the customer. Furthermore, since the different tools an agent uses are not integrated with each other and/or aware of the overall network environment in which they operate, these tools cannot select the most appropriate actions that may be performed to address the one or more problems.

### SUMMARY

In example embodiments, methods, systems, and computer-readable storage media are disclosed for determining the current status of a network (e.g., a cellular network) to which an IoT device is connected in real-time and/or effecting network changes, such as changing carriers or increasing or decreasing allocated data limits pertaining to the IoT device.

In example embodiments, one or more of the disclosed functions may be invoked automatically without manual input from an agent via the GUI (e.g., based on rules specifying conditions under which the functions are to be invoked automatically).

In example embodiments, methods, systems, and computer-readable media are disclosed for dynamically configuring or customizing a graphical user interface (GUI) of a desktop of an agent in real time with user interface elements for accessing one or more functions for servicing a customer with regard to one or more problems identified with respect to an IoT device of the customer.

In example embodiments, real-time analytics are performed on data pertaining to operation of the IoT device. For example, the device may be monitored to proactively or automatically request or perform maintenance and/or push firmware updates to the device at optimal tittles.

In example embodiments, a method of automatically disambiguating a problem with a network from a problem with an IoT device in real time is disclosed. Data related to an Internet of Things (IoT) device is programmatically accessed via a network (e.g., a cellular network) to which the IoT device is connected. In response to an Application Programming Interface (API) request, data related to the network is received. An aggregation of the data related to the IoT device and the data related to a network is generated for presentation in a user interface. The aggregation indicates a probability that a problem related to operability of the IoT device is related to a problem with the network.

In example embodiments, a support ticket is automatically opened in real-time based on the indication that the problem related to the operability of the IoT device is related to the problem with the network.

In example embodiments, a user of the IoT device is automatically notified of the indication in real-time.

In example embodiments, the network is changed to a different network based on the problem indication.

In example embodiments, based on the problem indication, a user interface element is automatically provided in the user interface, wherein the network change is further based on the activation of the user interface element.

In example embodiments, the data related to the IoT device includes an International Mobile Equipment Identity (imei) of the IoT device, and the method includes determining that the imei has changed from a previously recorded imei and, based on the determining, calling an API function to cause a disabling of the IoT device.

Example embodiments include determining that there is a change in usage of the IoT device that is higher than a threshold amount of data usage on a device. One or more possible actions are determined in response to the change in the usage. At least one user interface element is presented in the user interface, which corresponds to the one or more possible actions.

In example embodiments, the actions include an action for disabling the IoT device from accessing the network.

In example embodiments, one or more actions include an action for removing the device from the network and connecting the device to an additional network.

In example embodiments, the different network is identified based on data related to the different network that is received in response to the API request or an additional API request.

In example embodiments, a device includes computer processors and/or or a non-transitory computer-readable medium storing instructions that, when executed by one or more computer processors of a recipient client device, cause the recipient client device to perform operations that, when executed by the one or more computer processors, cause the device to perform operations to automatically disambiguate a problem with a network from a problem with an IoT device in real time. These instructions include programmatically accessing data related to an Internet of Things (IoT) device via a network to which the IoT device is connected. In response to an API request, data related to the network is received. An aggregation of the data related to the IoT device is generated. The data relating to the network and the aggregation of data related to the IoT device are presented on a user interface. The aggregation indicates a probability that a problem related to operability of the IoT device is related to a problem with the network.

Example embodiments include a device wherein the operations further include automatically opening a support ticket in real-time based on the indication that the problem related to the operability of the IoT device is related to the problem with the network.

Example embodiments include a device wherein the operations further include automatically notifying a user of the IoT device of the indication in real-time.

Example embodiments include a non-transitory computer-readable medium, wherein the operations further include automatically opening a support ticket in real-time based on the indication that the problem related to the operability of the IoT device is related to the problem with the network.

Example embodiments include a non-transitory computer-readable medium, wherein the operations include automatically notifying a user of the IoT device of the indication in real-time.

Example embodiments include a non-transitory computer-readable medium, wherein the data related to the IoT device includes an International Mobile Equipment Identity (imei) of the IoT device, and the method further includes determining that the imei has changed from a previously recorded imei and based on the determining, calling an API function to cause a disabling of the IoT device.

Example embodiments include a non-transitory computer-readable medium, wherein the operations further include: based on the data related to the IoT device, determining that there is a change in usage of the IoT device that is higher than a threshold amount of data usage; determining one or more possible actions to take in response to the change in the usage; and causing one or more user interface elements to be presented in the user interface, the one or more user interface elements corresponding to the one or more possible actions.

### BRIEF DESCRIPTION OF THE DRAWINGS

The appended drawings merely illustrate example embodiments of the present disclosure and cannot be considered to be limiting its scope.

FIG. 1 shows a system according to some embodiments.

FIG. 2 is a flow diagram showing the network status tools at a high level, according to some example embodiments.

FIG. 3 is an image of an agent desktop user interface) that includes options for determining network status, according to some example embodiments.

FIG. 4 is a flowchart of a method for customizing a single UI with all the information required to service a customer with regard to an IoT device that is network connected.

FIG. 5 is a flowchart of a method for customizing a single UI with all the information required to service a customer with regard to an IoT device that is network connected.

FIG. 6 is a block diagram illustrating a representative software architecture, which may be used in conjunction with various hardware architectures herein described.

FIG. 7 is a block diagram illustrating an example of a machine upon or by which one or more example process embodiments described herein may be implemented or controlled,

FIG. 8 is a block diagram illustrating components of a machine, according to some example embodiments, able to read instructions from a machine-readable medium (e.g., a machine-readable storage medium) and perform any one or more of the methodologies discussed herein.

### DETAILED DESCRIPTION

Example methods, systems, and computer programs are directed to storage media for programmatically accessing and/or configuring Internet of Things (IoT) devices. Examples merely typify possible variations. Unless explicitly stated otherwise, components and functions are optional and may be combined or subdivided, and operations may vary in sequence or be combined or subdivided. In the following description, for purposes of explanation, nonferrous specific details are set forth to provide a thorough understanding of example embodiments. However, it will be evident to one skilled in the art that the present subject matter may be practiced without these specific details.

Methods, systems, and computer programs are presented for programmatically accessing data related to an Internet of Things (IoT) device via a network to which the IoT device is connected. In response to an API request, data related to the network is received. The agent desktop can pull network data is pulled from the data storage by using API calls. An aggregation of the data related to the network, the IoT device, and the customer is generated and presented to the user/agent on the agent desktop. The aggregation indicates whether a problem related to the operability of the IoT device is related to a problem with the network. Therefore, not only can product information and customer information be pulled into an agent desktop, but network area status information is also presented to the agent desktop, and/or appropriate actions for an agent to take to resolve the problem may be surfaced in the agent desktop or be performed automatically on behalf of the agent based on one or more rules being satisfied. Furthermore, network data can be pushed from the network provider into a database or similar storage, from where it can be read. A mobile network core accesses the network status information. Accessing the network status information using a dedicated mobile network core allows the data to be accessed and forwarded as needed in real-time or near real-time.

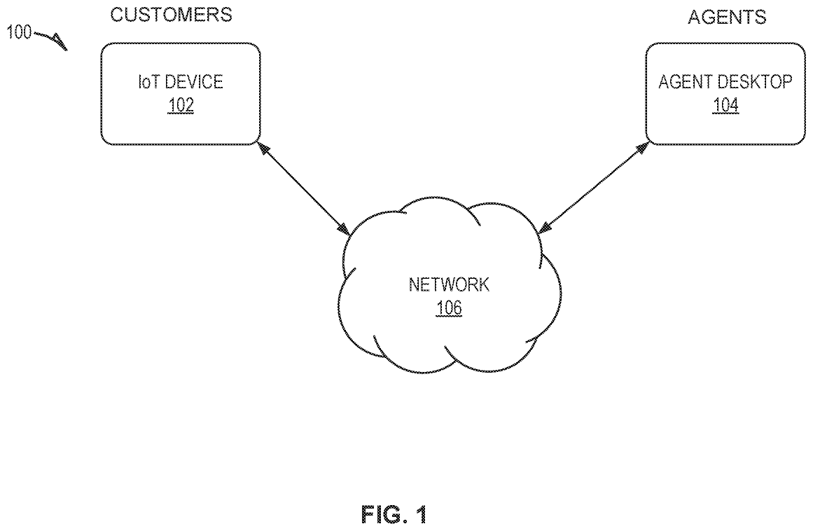

FIG. 1 shows a system according to some embodiments. As shown, system 100 includes multiple devices (i.e., IoT device 102 and agent desktop 104) connected to a communication network such as a network 106. While represented in FIG. 1 as a single IoT device 102 and a single network 106, these may include a fleet of IoT devices 102 and a series of cellular networks 106 interconnected with each other. The IoT device 102 is configured to communicate with the agent desktop 104 through the communication network 106, In some example embodiments, the agent desktop 104 is a part of a call center.

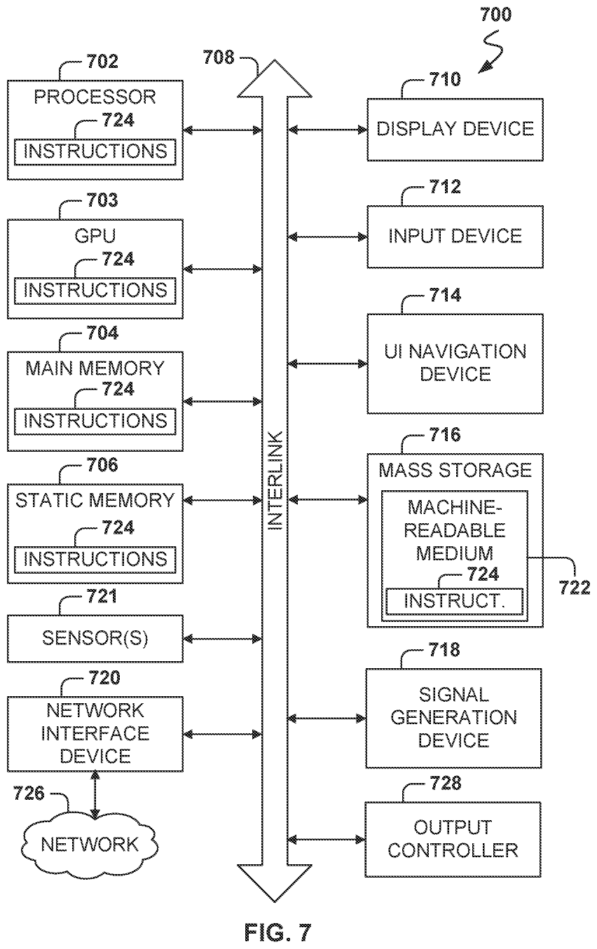

Multiple computing devices can be connected to the network 106, A computing device is any type of general computing device capable of network communication with other computing devices. For example, a computing device can be a personal computing device such as a desktop or workstation, a business server, or a portable computing device, such as a laptop, a smartphone, or a tablet personal computer (PC). A computing device can include some or all of the features, components, and peripherals of the machine 700 shown in FIG. 7.

To facilitate communication with other computing devices, a computing device includes a communication interface configured to receive a communication, such as a request, data, and the like, from another computing device in network communication with the computing device and pass the communication along to an appropriate module running on the computing device. The communication interface is also configured to send a communication to another computing device in network communication with the first computing device.

Although the system 100, as shown, includes only one IoT device 102 and one network 106, this is only for ease of explanation and is not meant to be limiting. The system 100 can include any number of IoT devices 102 and/or networks 106.

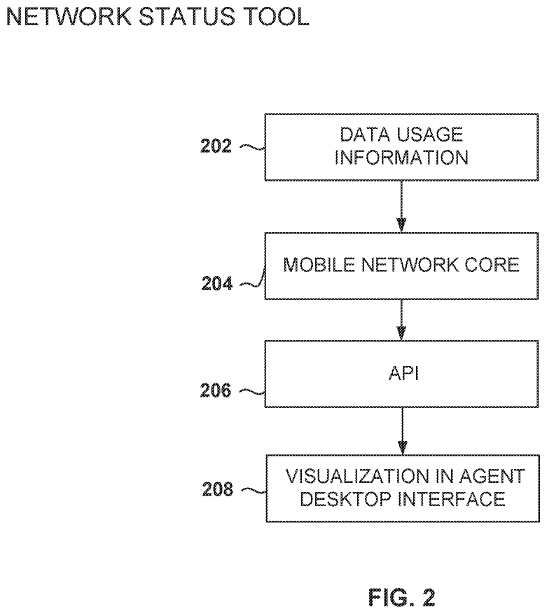

FIG. 2 is a flow diagram showing the network status tools at a high level, according to some example embodiments. The network status tool gets the data usage information 202 and can send or forward that information to a mobile network core 204. The mobile network core 204 forwards the information to be available for use or further processing by available API 206. Customer information related to the IoT device 102 is received by the API 206 and processed with the data usage information 202. The data relating to the network status may then be presented via the visualization on the agent desktop interface 208.

In some examples, the agent or an administrator can specify rules that determine whether particular actions may be taken automatically (e.g., at optimal times) without input from an administrator based on the data usage information 202. When an automatic action is being taken in response to the specified rule being triggered, a notification can also be automatically sent to the agent and/or the customer, informing them of the automatic action.

Data usage information 202 can include information about the IoT device 102, such as the particular international mobile equipment identity (imei), the international mobile subscriber identity (imsi), the IP address assigned, the amount of data uploaded from the device, and the amount of data downloaded from the device. Other related information related to the data usage of a particular IoT device 102 or even a fleet of IoT devices 102 may be determined.

The API 206 provides the software functions that enable an IoT device to interact with the wireless capabilities of the network 106 independent of radio technologies such as 3G, 4G-LTE, LTE-M, NB-IoT, 5G, or any other comparable radio technology. The API 206 authenticates the IoT devices 102 to determine if they are allowed on a particular wireless network. Furthermore, the API 206 routes data through the network, including breaking out the data to the internet.

The data routed through the API 206 may then be used by a particular API or APIs that uses the data for further backend processing. The system uses the data processed by the particular API or APIs to identify the problem with the IoT device 102 and/or to identify the problem with the network 106. A solution to the identified problem (either to the IoT device 102 or the network 106) is presented to the agent via the agent desktop interface 208.

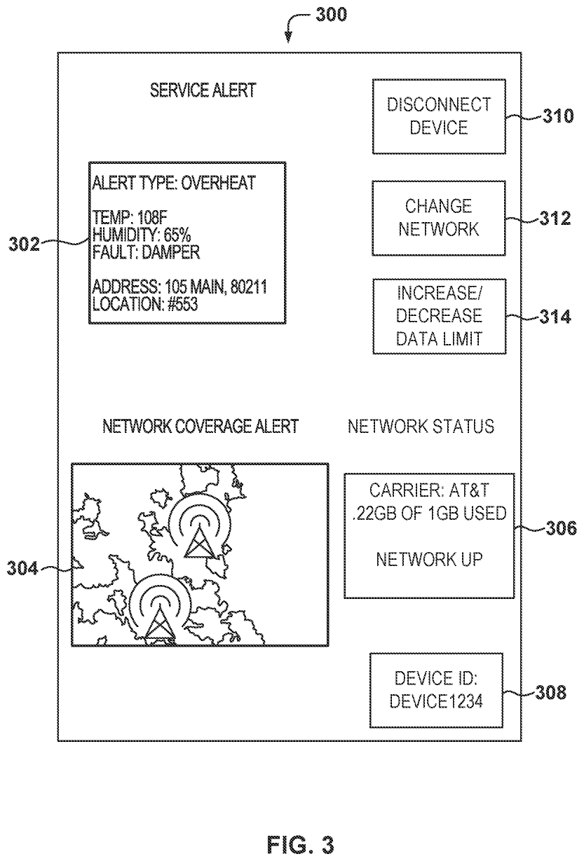

FIG. 3 is an image of an agent desktop UI 300 that includes options for determining network status, according to some example embodiments. The UI 300 presents an example of an agent desktop. Other configurations are possible depending on the needs of the agent.

The agent desktop UI 300 on the agent desktop 104 can provide a visual representation of any service alerts 302 and visual representations of the current network coverage status 304. A visual representation of the network coverage status 304 would allow the agent to see the area that the network currently is covering and provide information detailing any area where the network is down as it relates to the location of the IoT device 102.

The agent desktop UT 300 also may include a series of interfaces that allow the agent to perform particular actions and functions related to the network and IoT device 102 by interacting with the interface. The selection is based on the identified problem with the device and/or the identified problem (or lack of identified problem) with the network. These may include a Disconnect Device Interface 310 to disconnect a particular IoT device 102 currently on the network. A Change Network Interface 312 allows the agent to manually change the network servicing the IoT device 102. An Increase/Decrease Data Limit Interface 314 allows the agent to change the data limit associated with a particular IoT device 102. These functions may be selected from a plurality of functions that may include other functions determined to be related to possible solutions an agent would perform in addressing problems related to the IoT device 102 and/or the network 106.

In some examples, the agent can contact the user of the IoT device 102 through a CRM (customer relationship management) interface to get permission to resolve any issues that the agent is alerted to through the agent desktop UI 300. The OW interface surfaces information on the agent desktop 104 that informs the agent about the network data, the device data, and the customer data. The desktop UI 300 can present different functions to the agent in real-time while the agent is engaged in a communication with the customer. These different functions are integrated into a LI that includes various contextual information. Information about the customers historical data usage and the current data user may be presented on the agent desktop UI 300 in response to determining that the data of the IoT device has exceeded the current data limit. Functionality for providing the agent to contact the customer (not shown) as well as to disconnect the device from the network by using the Disconnect Device Interface 310 and/or change the data limit to a new threshold data limit by using an Increase/Decrease Data Limit Interface 314 may be presented to the agent based on the context device. For example, an IoT device 102 that controls an air-conditioning unit in a server room has a historical data usage threshold based on monitoring and controlling the temperature of the server room. In response to detecting the current data usage being greater than the historical data usage threshold, the agent desktop may automatically deactivate the network 106 communication with the IoT device 102. In addition to surfacing user interface elements on the agent desktop 104 for invoking functionalities of the IoT device 102 and/or network 106 by the network provider, the functionalities may be automatically invoked based on rules being satisfied (e.g., a certain threshold being reached with respect to data usage, and etc.). The agent may completely, automate the response to issues alerted by the agent desktop UI 300. The function of the interface elements can be automatically invoked based on rules set up by the agent on the agent desktop 104 to respond to the determined problems of the IoT device 102 and/or the network 106. In some cases, multiple functions are related to the possible responses to the determined problem of the IoT devices 102 and/or the network 106 based on the context related to the data usage.

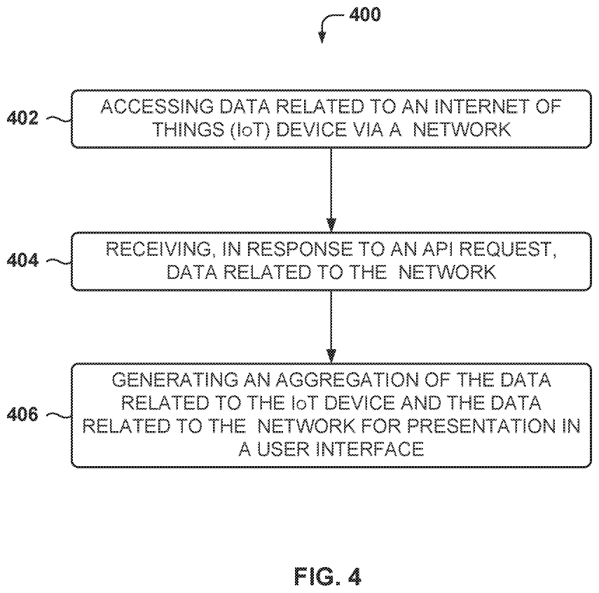

FIG. 4 is a flowchart of a method 400 for customizing a single UI with all the information required to service a customer with regard to an IOT device that is cellularly connected. While the various operations in this flowchart are presented and described sequentially, one of ordinary skill will appreciate that some or all of the operations may be executed in a different order, be combined or omitted, or be executed in parallel.

At operation 402, the agent desktop 104 accesses data related to the IoT device 102 via a network 106. This data may include information related to data usage over the network 106 of the IoT device 102. In some embodiments, the network 106 is a cellular network. Other data accessed by the agent desktop in some embodiments includes information related to device identification (ID), errors encountered by the device, location information of placement of cell towers that the device is connected to, or other information.

At operation 404, in response to an API request, data related to the network 106 is received by the agent desktop 104.

Different APIs can send one or more requests for data. In some examples, events related to the status of the IoT device 102 can be sent to the agent desktop by an event stream API to consume real-time event information data on the IoT device 102 and/or the network 106. In some examples, embodiments of each agent can control which particular containers, such as a CRM container, packages of multiple API and SDKs (Software Development Kit), or individual APIs and SDKs, may be used by the agent desktop 104. The agent desktop 104 is customized by the agent for the particular agent desktop 104 or customized by the agent for a particular IoT device 102.

At operation 406, an aggregation of the data related to the IoT′ device and the data related to the cellular network is generated for presentation in a user interface.

The information can be sent on the agent desktop 104 on an agent desktop UI 300. This agent desktop can be customizable to provide the functionality that different agents require. By aggregating data, the agent can determine the precise network information and accelerate the resolution process for responding to user calls related to IoT devices 102.

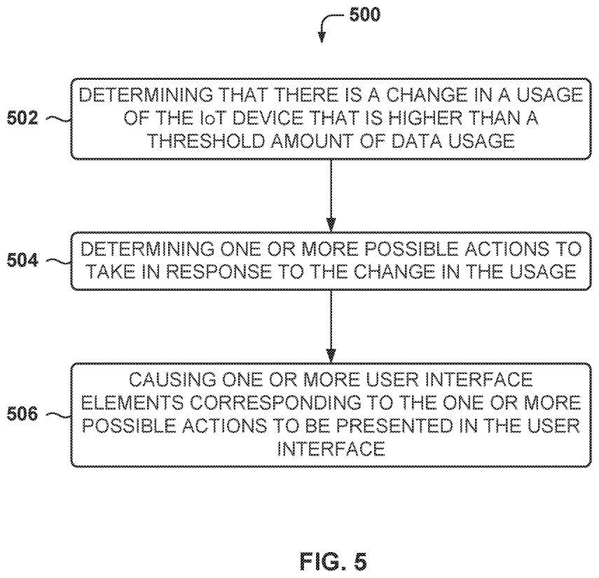

FIG. 5 is a flowchart of a method 500 for customizing a single Lal with the information required to service a customer regarding an IoT device 102 connected to a network 106. In some examples, the network 106 may be a cellular network. While the various operations in this flowchart are presented and described sequentially, one of ordinary skill will appreciate that some or all of the operations may be executed in a different order, be combined or omitted, or be executed in parallel.

Operation 502 determines that a problem related to an IOT device has transgressed a problem threshold.

In some examples, information about the data usage of the IoT device 102 can be sent to the agent desktop 104, and prior to presenting the data to the agent, the agent desk, an assessment of the data usage is performed to determine if the usage is consistent with the expected usage of the IoT device. For example, a device that is expected to require less than 500 MB of data in a month has increased to using over 1 GB at the time of the data assessment.

Operation 504 determines one or more possible actions to take in response to the problem related to the IoT device 102. In some examples, these one or more possible actions are taken in response to a problem related to the network 106.

In the example where a threshold data usage is set for an IoT and a change in usage data is determined to be higher than a threshold amount of data usage of the IoT device, the system can determine a series of possible actions to resolve this problem. For example, the data usage threshold may be increased, the permission to use data over the network to the IoT device may be turned off completely, or the network may be switched from the current network to a second network with a different data usage threshold.

A number of actions that the agent can take can be determined in response to the problem related to the IoT device 102. APIs can be used to allow for possible actions to be taken in response to changes in usage. For example, when no data is being used, and the network status has been determined, to be down, the agent can use a network change API, such as a task router or other similar API, to change the network 106 connected to the IoT device 102. In another example, a voice. API can call the user of the IoT device 102 to inform them of the changes to the device status, or a text or a Short Message Service (SMS) may be sent to either an owner of an IoT device 102 or an approved service technician of the IoT device 102. Other possible actions in response to the change in usage may be determined, and the functionality of different APIs available to the agent by the agent desktop 104 may be considered.

At operation 506, one or more user interface elements corresponding to one or more possible actions are presented in the user interface.

On the agent desktop UI 300, any of the interfaces (302-314) can automatically be presented to the agent on the agent desktop 104. The agent can choose between the functions presented to the agent for actions to respond to the problem related to the IoT device 102 and/or the problem related to the network 106. For example, on the agent desktop 104, the agent desktop UI 300 can present a series of buttons that the agent can interact with to perform an action that would resolve the problem related to the IoT device 102 and/or the network 106. For example, the interactive interface on the agent desktop UI 300 can include a button for actions such as changing the device ID by using the Device ID Interface 308, disconnecting the device from the network by using the Disconnect Device Interface 310, changing the network by using the Change Network Interface 312, and/or changing the data threshold value to either a higher or lower data limit by using the Increase/Decrease Data Limit Interface 314. These interfaces may be presented to the agent on the agent desktop 104 to allow the agent to execute the possible actions in response to the change in usage by, the IoT device 102. Other functionality may be presented to the agent on the agent desktop 104, such as sending updates to the firmware IoT device 102.

In some examples, a rule may be set by the agent on the agent desktop 104 that automatically performs any one of the functions or a series of functions as determined by the system in response to the determined problem related to the IoT device 102 and/or the network 106. For example, if the current local network carrier is determined to be down and the network status of the network 106 is determined to be down, the agent desktop 104 can automatically change the network carrier to one that is determined to be up.

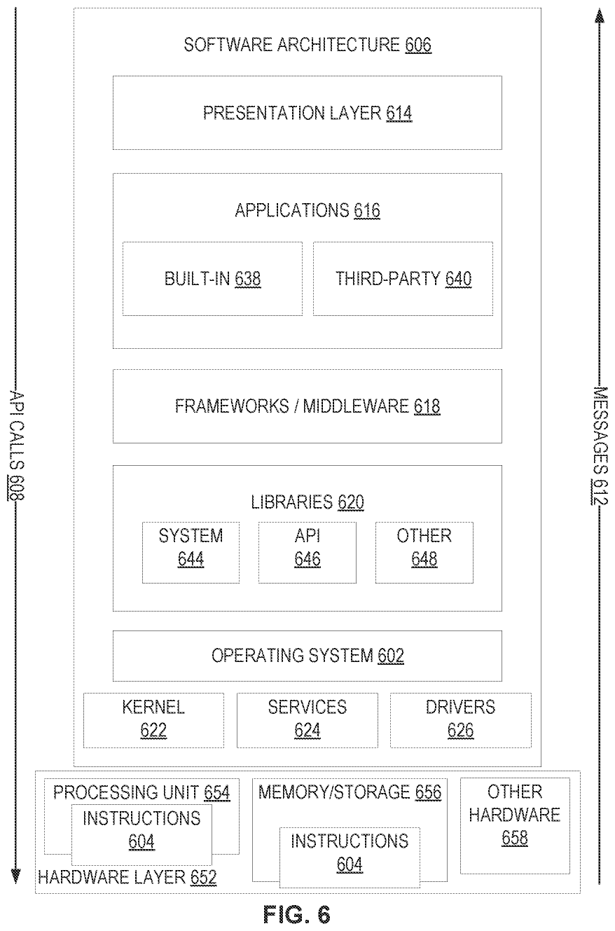

FIG. 6 is a block diagram illustrating an example software architecture 606, which may be used in conjunction with various hardware architectures herein described. FIG. 6 is a non-limiting example of a software architecture 606 and it will be appreciated that many other architectures may be implemented to facilitate the functionality described herein. The software architecture 606 may execute on hardware such as machine 700 of FIG. 7 that includes, among other things, processors 702 memory 704, and (input/output) I/O components 712 and 728. A representative hardware layer 652 is illustrated and can represent, for example, the machine 700 of FIG. 7. The representative hardware layer 652 includes a processing unit 654 having associated executable instructions 604, Executable instructions 604 represent the executable instructions of the software architecture 606, including implementation of the methods, components, and so forth described herein. The hardware layer 652 also includes memory and/or storage modules 656, which also have executable instructions 604, The hardware layer 652 may also comprise other hardware 658.

In the example architecture of FIG. 6, the software architecture 606 may be conceptualized as a stack of layers where each layer provides particular functionality. For example, the software architecture 606 may include layers such as an operating system 602, libraries 620, frameworks/middleware 618, applications 616, and a presentation layer 614. Operationally, the applications 616 and/or other components within the layers may invoke application programming interface (API) calls 608 through the software stack and receive a response such as messages 612 in response to the API calls 608. The layers illustrated are representative in nature and not all software architectures have all layers. For example, some mobile or special purpose operating systems may not provide a frameworks/middleware 618, while others may provide such a layer. Other software architectures may include additional or different layers.

The operating system 602 may manage hardware resources and provide common services. The operating system 602 may include, for example, a kernel 622, services 624, and drivers 626. The kernel 622 may act as an abstraction layer between the hardware and the other software layers. For example, the kernel 622 may be responsible for memory management, processor management (e.g., scheduling), component management, networking, security settings, and so on. The services 624 may provide other common services for the other software layers. The drivers 626 are responsible for controlling or interfacing with the underlying hardware. For instance, the drivers 626 include display drivers, camera drivers, Bluetooth® drivers, flash memory drivers, serial communication drivers (e.g., Universal Serial Bus (USB) drivers), Wi-Fi® drivers, audio drivers, power management drivers, and so forth, depending on the hardware configuration.

The libraries 620 provide a common infrastructure that is used by the applications 616 and/or other components and/or layers. The libraries 620 provide functionality that allows other software components to perform tasks in an easier fashion than to interface directly with the underlying operating system 602 functionality (e.g., kernel 622, services 624, and/or drivers 626), The libraries 620 may include system libraries 644 (e.g., C standard library) that may provide functions such as memory allocation functions, string manipulation functions, mathematical functions, and the like. In addition, the libraries 620 may include API libraries 646 such as media libraries (e.g., libraries to support presentation and manipulation of various media format such as MPEG4, H264, MP3, AAC, AMR, JPG, PNG), graphics libraries (e.g., an OpenGt framework that may be used to render 2D and 3D in a graphic content on a display), database libraries (e.g., SQLite that may provide various relational database functions), web libraries (e.g., WebKit that may provide web browsing functionality), and the like. The libraries 620 may also include a wide variety of other libraries 648 to provide many other APIs to the applications 616 and other software components/modules.

The frameworks/middleware 618 (also sometimes referred to as middleware) provide a higher-level common infrastructure that may be used by the applications 616 and/or other software components/modules. For example, the frameworks/middleware 618 may provide various graphical user interface (GUI) functions, high-level resource management, high-level location services, and so forth. The frameworks/middleware 618 may provide a broad spectrum of other APIs that may be used by the applications 616 and/or other software components/modules, some of which may be specific to a particular operating system 602 or platform.

The applications 616 include built-in applications 638 and/or third-party applications 640. Examples of representative built-in applications 638 may include, but are not limited to, a contacts application, a browser application, a book reader application, a location application, a media application, a messaging application, and/or a game application. Third-party applications 640 may include an application developed using the ANDROID™ or IOS™ software development kit (SDK) by an entity other than the vendor of the particular platform, and may be mobile software running on a mobile operating system such as IOS™, ANDROID™ WINDOWS® Phone, or other mobile operating systems. The third-party applications 640 may invoke the API calls 608 provided by the mobile operating system (such as operating system 602) to facilitate functionality described herein.

The applications 616 may use built in operating system functions (e.g., kernel 622, services 624, and/or drivers 626), libraries 620, and frameworks/middleware 618 to create UIs to interact with users of the system. Alternatively, or additionally, in some systems, interactions with a user may occur through a presentation layer, such as presentation layer 614. In these systems, the application/component “logic” can be separated from the aspects of the application/component that interact with a user.

FIG. 7 is a block diagram of an example computer system 700 on which methodologies and operations described herein may be executed in accordance with an example embodiment. In alternative embodiments, the machine operates as a standalone device or may be connected (e.g., networked) to other machines. In a networked deployment, the machine may operate in the capacity of a server or a client machine in a server-client network environment or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further. While only a single machine is illustrated, the term “machine” shall also be taken to include any collection of machines that individually or jointly execute a set (or multiple sets) of instructions to perform any one or more of the methodologies discussed herein.

The example computer system 700 includes a processor 702 (e.g., a central processing unit (CPU), a graphics processing unit (GPU), or both), a main memory 704, and a static memory 706, which communicate with each other via a bus 708. The computer system 700 may further include a display device 710 (e.g., a liquid crystal display (LCD) or a cathode ray tube (CRT)). The computer system 700 also includes an alphanumeric input device 712 (e.g., a keyboard or a touch-sensitive display screen), a user interface (UI) navigation device 714 (e.g., a mouse), a storage unit 716, a signal generation device 718 (e.g., a speaker) and a network interface device 720.

Machine-Readable Medium

The storage unit 716 includes a machine-readable medium 722 on which is stored one or more sets of instructions and data structures (e.g., software) 724 embodying or utilized by any one or more of the methodologies, operations, or functions described herein. The instructions 724 may also reside, completely or at least partially, within the main memory 704 and/or within the processor 702 during execution thereof by the computer system 700, the main memory 704 and the processor 702 also constituting machine-readable media.

While the machine-readable medium 722 is shown in an example embodiment to be a single medium, the term “machine-readable medium” may include a single medium or multiple media (e.g., a database (either centralized or distributed), and/or associated caches and servers) that store the one or more instructions 724 or data structures. The term “machine-readable medium” shall also be taken to include any tangible medium that is capable of storing, encoding, or carrying instructions (e.g., instructions 724) for execution by the machine and that cause the machine to perform any one or more of the methodologies of the present disclosure, or that is capable of storing, encoding or carrying data structures utilized by or associated with such instructions. The term “machine-readable medium” shall accordingly be taken to include, but not be limited to, solid-state memories and optical and magnetic media. Specific examples of machine-readable media include non-volatile memory, including by way of example—semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

Transmission Medium

The instructions 724 may further be transmitted or received over a communications network 726 using a transmission medium. The instructions 724 may be transmitted using the network interface device 720 and any one of a number of well-known transfer protocols (e.g., HTTP). Examples of communication networks include a local area network (“LAN”), a wide area network (“WAN”), the internet, mobile telephone networks, Plain Old Telephone Service (POTS) networks, and wireless data networks (e.g., WiFi and WiMax networks). The term “transmission medium” shall be taken to include any intangible medium capable of storing, encoding, or carrying instructions for execution by the machine and includes digital or analog communications signals or other intangible media to facilitate communication of such software.

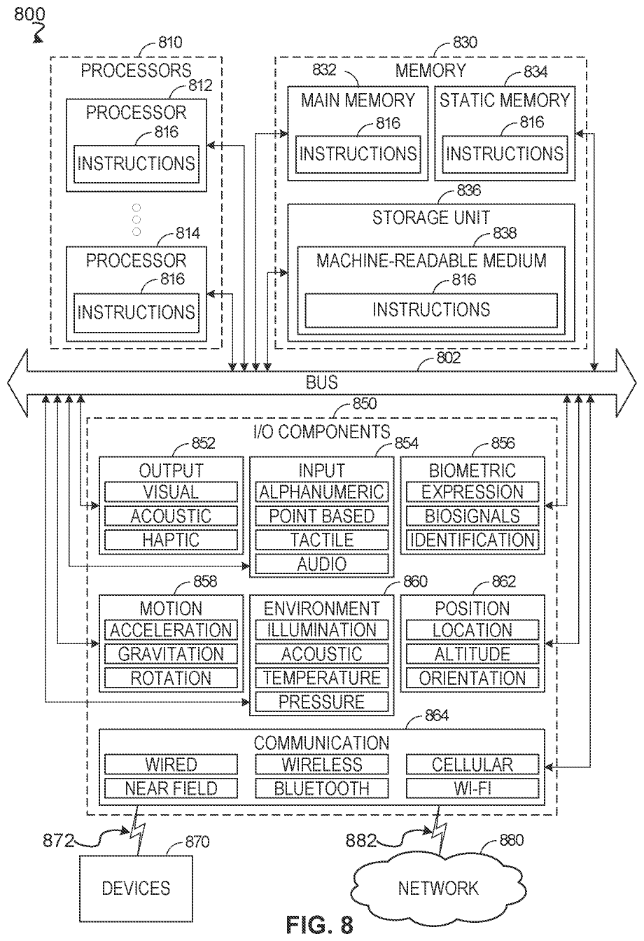

FIG. 8 is a block diagram illustrating components of a machine 800, according to some example embodiments, able to read instructions from a machine-readable medium (e.g., a machine-readable storage medium) and perform any one or more of the methodologies discussed herein. Specifically, FIG. 8 shows a diagrammatic representation of the machine 800 in the example form of a computer system, within which instructions 816 (e.g., software, a program, an application, an applet, an app, or other executable code) for causing the machine 800 to perform any one or more of the methodologies discussed herein may be executed. As such, the instructions 816 may be used to implement modules or components described herein. The instructions 816 transform the general, non-programmed machine 800 into a particular machine 800 programmed to carry out the described and illustrated functions in the manner described. In alternative embodiments, the machine 800 operates as a standalone device or may be coupled (e.g., networked) to other machines. In a networked deployment, the machine 800 may operate in the capacity of a server machine or a client machine in a server-client network environment, or as a peer machine in a peer-to-peer (or distributed) network environment. The machine 800 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smartphone, a mobile device, a wearable device (e.g., a smart watch), a smart home device (e.g., a smart appliance), other smart devices, a web appliance, a network router, a network switch, a network bridge, or any machine capable of executing the instructions 816, sequentially or otherwise, that specify actions to be taken by the machine 800. Further, while only a single machine 800 is illustrated, the term “machine” shall also be taken to include a collection of machines that individually or jointly execute the instructions 816 to perform any one or more of the methodologies discussed herein.

The machine 800 may include processors 810, memory/storage 830, and I/O components 850, which may be configured to communicate with each other such as via a bus 802. The memory/storage 830 may include a main memory 832, static memory 834, and a storage unit 836, both accessible to the processors 810 such as via the bus 802. The storage unit 836 and main memory 832 store the instructions 816 embodying any one or more of the methodologies or functions described herein. The instructions 816 may also reside, completely or partially, within the static memory 834, within the storage unit 836 (e.g., on machine readable-medium 838), within at least one of the processors 810 (e.g., within the processor cache memory accessible to processors 812 or 814), or any suitable combination thereof, during execution thereof by the machine 800. Accordingly, the main memory 832, static memory 834, the storage unit 836, and the memory of the processors 810 are examples of machine-readable media.

The I/O components 850 may include a wide variety of components to receive input, provide output, produce output, transmit information, exchange information, capture measurements, and so on. The specific I/O components 850 that are included in a particular machine 800 will depend on the type of machine. For example, portable machines such as mobile phones will likely include a touch input device or other such input mechanisms, while a headless server machine will likely not include such a touch input device. It will be appreciated that the I/O components 850 may include many other components that are not shown in FIG. 8. The I/O components 850 are grouped according to functionality merely for simplifying the following discussion and the grouping is in no way limiting. In various example embodiments, the I/O components 850 may include output components 852 and input components 854. The output components 852 may include visual components (e.g., a display such as a plasma display panel (PDP), a light-emitting diode (LED) display, a liquid-crystal display (LCD), a projector, or a cathode ray tube (CRT)), acoustic components (e.g., speakers), haptic components (e.g., a vibratory motor, resistance mechanisms), other signal generators, and so forth. The input components 854 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or other pointing instruments), tactile input components (e.g., a physical button, a touch screen that provides location and/or force of touches or touch gestures, or other tactile input components), audio input components (e.g., a microphone), and the like.

In further example embodiments, the I/O components 850 may include biometric components 856, motion components 858, environment components 860, or position components 862 among a wide array of other components. For example, the biometric components 856 may include components to detect expressions (e.g., hand expressions, facial expressions, vocal expressions, body gestures, or eye tracking), measure biosignals blood pressure, heart rate, body temperature, perspiration, or brain waves), identify a person (e.g., voice identification, retinal identification, facial identification, fingerprint identification, or electroencephalogram-based identification), and the like. The motion components 858 may include acceleration sensor components (e.g., accelerometer), gravitation sensor components, rotation sensor components (e.g., gyroscope), and so forth. The environment components 860 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), or other components that may provide indications, measurements, or signals corresponding to a surrounding physical environment. The position components 862 may include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 850 may include communication components 864 operable to couple the machine 800 to a network 880 or devices 870 via a coupling 882 and a coupling 872, respectively. For example, the communication components 864 may include a network interface component or other suitable device to interface with the network 880. In further examples, the communication components 864 may include wired communication components, wireless communication components, cellular communication components, near field communication (NFC) components, Bluetooth® components (e.g., Bluetooth® Low Energy), Wi-Fi® components, and other communication components to provide communication via other modalities. The devices 870 may be another machine or any of a wide variety of peripheral devices e.g., a peripheral device coupled via a USB).

Moreover, the communication components 864 may detect identifiers or include components operable to detect identifiers. For example, the communication components 864 may include radio frequency identification (RFID) tag reader components, NFC smart tag detection components, optical reader components (e.g., an optical sensor to detect one-dimensional barcodes such as Universal Product Code (UPC) barcode, multi-dimensional barcodes such as Quick Response (QR) code, Aztec code, Data Matrix, Dataglyph, MaxiCode, PDF 418, Ultra Code, UCC IRS-2D barcode, and other optical codes), or acoustic detection components (e.g., microphones to identify tagged audio signals). In addition, a variety of information may be derived via the communication components 864, such as location via Internet Protocol (IP) geolocation, location via Wi-Fi® signal triangulation, location via detecting an NFC beacon signal that may indicate a particular location, and so forth.

### Glossary

“CARRIER SIGNAL” in this context refers to any intangible medium that is capable of storing, encoding, or carrying instructions 816 for execution by the machine 800, and includes digital or analog communications signals or other intangible media to facilitate communication of such instructions 816. Instructions 816 may be transmitted or received over the network 880 using a transmission medium via a network interface device and using any one of a number of well-known transfer protocols.

“CLIENT DEVICE” in this context refers to any machine 800 that interfaces to a network 880 to obtain resources from one or more server systems or other client devices (e.g., client device 775). A client device may be, but is not limited to, a mobile phone, desktop computer, laptop, PDA, smartphone, tablet, ultrabook, netbook, multi-processor system, microprocessor-based or programmable consumer electronics system, game console, set-top box, or any other communication device that a user may use to access a network 880.

“COMMUNICATIONS NETWORK” in this context refers to one or more portions of a network 880 that may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the internet, a portion of the internet, a portion of the Public Switched Telephone Network (PSTN), a plain old telephone service (POTS) network, a cellular telephone network, a wireless network, a Wi-Fi® network, another type of network, or a combination of two or more such networks. For example, a network or a portion of a network 880 may include a wireless or cellular network and the coupling 882 may be a Code Division Multiple Access (CDMA) connection, a Global System for Mobile communications (GSM) connection, or another type of cellular or wireless coupling. In this example, the coupling may implement any of a variety of types of data transfer technology, such as Single Carrier Radio Transmission Technology (IxRTT), Evolution-Data Optimized (EVDO) technology, General Packet Radio Service (GPRS) technology. Enhanced Data rates for GSM Evolution (EDGE) technology, third Generation Partnership Project (3GPP) including 3G, fourth generation wireless (4G) networks, Universal Mobile Telecommunications System (UMTS), High-Speed Packet Access (HSPA), Worldwide Interoperability for Microwave Access (WiMAX), Long-Term Evolution (LTE) standard, others defined by various standard-setting organizations, other long-range protocols, or other data transfer technology.

“MACHINE-READABLE MEDIUM” in this context refers to a component, a device, or other tangible media able to store instructions 816 and data temporarily or permanently and may include, but is not limited to, random-access memory (RAM), read-only memory (ROM), buffer memory, flash memory, optical media, magnetic media, cache memory, other types of storage (e.g., erasable programmable read-only memory (EPROM)), and/or any suitable combination thereof. The term “machine-readable medium” should be taken to include a single medium or multiple media (e.g., a centralized or distributed database, or associated caches and servers) able to store instructions 816. The term “machine-readable medium” shall also be taken to include any medium, or combination of multiple media, that is capable of storing instructions 816 (e.g., code) for execution by a machine 800, such that the instructions 816, when executed by one or more processors 810 of the machine 800, cause the machine 800 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

“COMPONENT” in this context refers to a device, a physical entity, or logic having boundaries defined by function or subroutine calls, branch points, APIs, or other technologies that provide for the partitioning or modularization of particular processing or control functions, Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components.

A “hardware component” is a tangible unit capable of performing certain operations and may be configured or arranged in a certain physical manner. In various example embodiments, one or more computer systems (e.g., a standalone computer system, a client computer system, or a server computer system) or one or more hardware components of a computer system (e.g., a processor 812 or a group of processors 810) may be configured by software (e.g., an application or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a field-programmable gate array (FPGA) or an application-specific integrated circuit (ASIC). A hardware component may also include programmable logic or circuitry that is temporarily configured by software to perform certain operations. For example, a hardware component may include software executed by a general-purpose processor or other programmable processor. Once configured by such software, hardware components become specific machines (or specific components of a machine 800) uniquely tailored to perform the configured functions and are no longer general-purpose processors 810.

It will be appreciated that the decision to implement a hardware component mechanically, in dedicated and permanently configured circuitry, or in temporarily configured circuitry (e.g., configured by software) may be driven by cost and time considerations. Accordingly, the phrase “hardware component” (or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein.

Considering embodiments in which hardware components are temporarily configured (e.g., programmed), each of the hardware components need not be configured or instantiated at any one instance in time. For example, where a hardware component comprises a general-purpose processor 812 configured by software to become a special-purpose processor, the general-purpose processor 812 may be configured as respectively different special-purpose processors (e.g., comprising different hardware components) at different times. Software accordingly configures a particular processor 812 or processors 810, for example, to constitute a particular hardware component at one instance of time and to constitute a different hardware component at a different instance of time.

Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In embodiments in which multiple hardware components are configured or instantiated at different times, communications between or among such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information).

The various operations of example methods described herein may be performed, at least partially, by one or more processors 810 that are temporarily configured (e.g., by software) or permanently configured to perform the relevant operations. Whether temporarily or permanently configured, such processors 810 may constitute processor-implemented components that operate to perform one or more operations or functions described herein. As used herein, “processor-implemented component” refers to a hardware component implemented using one or more processors 810. Similarly, the methods described herein may be at least partially processor-implemented, with a particular processor 812 or processors 810 being an example of hardware. For example, at least some of the operations of a method may be performed by one or more processors 810 or processor-implemented components. Moreover, the one or more processors 810 may also operate to support performance of the relevant operations in a “cloud computing” environment or as a “software as a service” (SaaS). For example, at least some of the operations may be performed by a group of computers (as examples of machines 800 including processors 810), with these operations being accessible via, a network 880 (e.g., the internet)) and via one or more appropriate interfaces (e.g., an API). The performance of certain of the operations may be distributed among the processors 810, not only residing within a single machine 800, but deployed across a number of machines 800. In some example embodiments, the processors 810 or processor-implemented components may be located in a single geographic location (e.g., within a home environment, an office environment, or a server farm) in other example embodiments, the processors 810 or processor-implemented components may be distributed across a number of geographic locations.

“PROCESSOR” in this context refers to any circuit or virtual circuit (a physical circuit emulated by logic executing on an actual processor 812) that manipulates data values according to control signals (e.g., “commands,” “op codes,” “machine code.” etc.) and which produces corresponding output signals that are applied to operate a machine 800. A processor may, for example, be a central processing unit (CPU), a reduced instruction set computing (RISC) processor, a complex instruction set computing (CISC) processor, a graphics processing unit (GPU), a digital signal processor (DSP), an ASIC, a radio-frequency integrated circuit (RFIC), or any combination thereof. A processor 810 may further be a multi-core processor 810 having two or more independent processors 812, 814 (sometimes referred to as “cores”) that may execute instructions 816 contemporaneously.

Although an embodiment has been described with reference to specific example embodiments, it will be evident that various modifications and changes may be made to these embodiments without departing from the broader spirit and scope of the present disclosure. Accordingly, the specification and drawings are to be regarded in an illustrative rather than a restrictive sense. The accompanying drawings that form a part hereof show specific embodiments in which the subject matter may be practiced by way of illustration, not of limitation. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. Therefore, this Detailed Description is not to be taken in a limiting sense, and the scope of various embodiments is defined only by the appended claims, along with the full range of equivalents to which such claims are entitled.

Although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

Components, or modules, shown in diagrams are illustrative of exemplary embodiments of the disclosure and are meant to avoid obscuring the disclosure. It shall also be understood that throughout this discussion, components may be described as separate functional units, which may comprise sub-units, but those skilled in the art will recognize that various components, or portions thereof, may be divided into separate components or may be integrated together, including integrated within a single system or component. It should be noted that functions or operations discussed herein may be implemented as components. Components may be implemented in software, hardware, or a combination thereof.

Furthermore, connections between components or systems within the figures are not intended to be limited to direct connections. Data between these components may be modified, re-formatted, or otherwise changed by intermediary components. Also, additional or fewer connections may be used. It shall also be noted that the terms “coupled,” “connected,” or “communicatively coupled” shall be understood to include direct connections, indirect connections through one or more intermediary devices, and wireless connections.

Reference in the specification to “one embodiment,” “preferred embodiment,” “an embodiment,” or “embodiments” means that a particular feature, structure, characteristic, or function described in connection with the embodiment is included in at least one embodiment of the disclosure and may be in more than one embodiment. Also, the appearances of the above-noted phrases in various places in the specification are not necessarily all referring to the same embodiment or embodiments.

The use of certain terms in various places in the specification is for illustration and should not be construed as limiting. The terms “include,” “including,” “comprise,” and “comprising” shall be understood to be open terms, and any lists that follow are examples and not meant to be limited to the listed items.

A service, function, or resource is not limited to a single service, function, or resource; usage of these terms may refer to a grouping of related services, functions, or resources, which may be distributed or aggregated. Terms such as memory, database, information base, data store, tables, hardware, and the like may be used herein to refer to system component or components into which information may be entered or otherwise recorded. The terms such as “data” or “information,” along with similar terms, may be replaced by other terminologies referring to a group of bits, and may be used interchangeably. The terms “packet” or “frame” shall be understood to mean a group of bits. The term “frame” shall not be interpreted as limiting embodiments of the present invention to Layer 2 networks, and the term “packet” shall not be interpreted as limiting embodiments of the present invention to Layer 3 networks. The terms “packet,” “frame,” “data,” or “data traffic” may be replaced by other terminologies referring to a group of bits, such as “datagram” or “cell.” The words “optimal,” “optimize,” “optimization,” and the like refer to an improvement of an outcome or a process and do not require that the specified outcome or process has achieved an “optimal” or peak state.

It shall be noted that: (1) certain steps may optionally be performed; (2) steps may not be limited to the specific order set forth herein; (3) certain steps may be performed in different orders; and (4) certain steps may be done concurrently.

Any headings used herein are for organizational purposes only and shall not be used to limit the scope of the description or the claims. Each reference/document mentioned in this patent document is incorporated by reference herein in its entirety.

It shall be noted that any examples provided herein are provided by way of illustration and under specific conditions using a specific embodiment or embodiments; accordingly, neither these examples nor their implementations shall be used to limit the scope of the disclosure of the current patent document.

It shall also be noted that although embodiments described herein may be within the context of client-side enrichment and transform, aspects of the present disclosure are not so limited. Accordingly, the aspects of the present disclosure may be applied or adapted for use in other contexts.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims and the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in the context of specific illustrative configurations. Other allocations of functionality are envisioned and may fall within the scope of various embodiments of the present disclosure. In general, structures and functionality presented as separate resources in the example configurations may be implemented as a combined structure or resource.

Similarly, structures and functionality presented as a single resource may be implemented as separate resources. These and other variations, modifications, additions, and improvements fall within a scope of embodiments of the present disclosure as represented by the appended claims. Accordingly, the specification and drawings are to be regarded in an illustrative rather than a restrictive sense.

1. A method comprising:
programmatically accessing data related to an Internet of Things (IoT) device via a cellular network to which the IoT device is connected;
receiving, in response to an API request, data related to the cellular network; and
generating an aggregation of the data related to the IoT device and the data related to the cellular network for presentation in a user interface, the aggregation providing an indication of whether a problem related to operability of the IoT device is related to a problem with the cellular network.

2. The method of claim 1, further comprising opening a support ticket automatically in real-time based on the indication that the problem related to the operability of the IoT device is related to the problem with the cellular network.

3. The method of claim 1, further comprising notifying a user of the IoT device of the indication in real-time.

4. The method of claim 1, further comprising, based on the indication, changing the cellular network to an additional cellular network.

5. The method of claim 4, further comprising, based on the indication, providing a user interface element in the user interface, and wherein the changing of the cellular network is further based on an activation of the user interface element.

6. The method of claim 1, wherein the data related to the IoT device includes an International Mobile Equipment Identity (imei) of the IoT device, and the method further comprises:
determining that the imei has changed from a previously recorded imei and, based on the determining, calling an API function to cause a disabling of the IoT device.

7. The method of claim 1, further comprising:
based on the data related to the IoT device, determining that there is a change in a usage of the IoT device that is higher than a threshold amount of data usage;
determining one or more possible actions to take in response to the change in the usage; and
causing one or more user interface elements to be presented in the user interface, the one or more user interface elements corresponding to the one or more possible actions.

8. The method of claim 7, wherein the actions include an action for disabling the IoT device from accessing the cellular network.

9. The method of claim 7, wherein the one or more actions include an action for removing the device from the cellular network and connecting the device to an additional cellular network.

10. The method of claim 9, where the additional cellular network is identified based on data related to the additional cellular network that is received in response to the API request or an additional API request.

11. A device comprising:
one or more computer processors; and
one or more computer-readable mediums storing instructions that, when executed by the one or more computer processors, cause the device to perform operations comprising:
programmatically accessing data related to an Internet of Things (IoT) device via a cellular network to which the IoT device is connected;
receiving, in response to an API request, data related to the cellular network; and
generating an aggregation of the data related to the IoT device and the data related to the cellular network for presentation in a user interface, the aggregation providing an indication of whether a problem related to operability of the IoT device is related to a problem with the cellular network.

12. The device of claim 11, wherein the operations further comprise opening a support ticket automatically in real-time based on the indication that the problem related to the operability of the IoT device is related to the problem with the cellular network.

13. The device of claim 11, wherein the operations further comprise notifying a user of the IoT device of the indication in real-time.

14. The device of claim 11, wherein the data related to the IoT device includes an International Mobile Equipment Identity (imei) of the IoT device, and the operations further comprise:
determining that the imei has changed from a previously recorded imei and, based on the determining, calling an API function to cause a disabling of the IoT device.

15. The device of claim 11, wherein the operations further comprise:
based on the data related to the IoT device, determining that there is a change in a usage of the IoT device that is higher than a threshold amount of data usage;
determining one or more possible actions to take in response to the change in the usage; and
causing one or more user interface elements to be presented in the user interface, the one or more user interface elements corresponding to the one or more possible actions.

16. A non-transitory computer-readable medium storing instructions that, when executed by one or more computer processors of a recipient client device, cause the recipient client device to perform operations comprising:
programmatically accessing data related to an Internet of Things (IoT) device via a cellular network to which the IoT device is connected;
receiving, in response to an API request, data related to the cellular network; and
generating an aggregation of the data related to the IoT device and the data related to the cellular network for presentation in a user interface, the aggregation providing an indication of whether a problem related to operability of the IoT device is related to a problem with the cellular network.

17. The non-transitory computer-readable medium of claim 16, wherein the operations further comprise opening a support ticket automatically in real-time based on the indication that the problem related to the operability of the IoT device is related to the problem with the cellular network.

18. The non-transitory computer-readable medium of claim 16, wherein the operations further comprise notifying a user of the IoT device of the indication in real-time.

19. The non-transitory computer-readable medium of claim 16, wherein the data related to the IoT device includes an International Mobile Equipment Identity (imei) of the IoT device, and the operations further comprise:
determining that the imei has changed from a previously recorded imei and, based on the determining, calling an API function to cause a disabling of the IoT device.

20. The non-transitory computer-readable medium of claim 16, wherein the operations further comprise:
based on the data related to the IoT device, determining that there is a change in a usage of the IoT device that is higher than a threshold amount of data usage;
determining one or more possible actions to take in response to the change in the usage; and
causing one or more user interface elements to be presented in the user interface, the one or more user interface elements corresponding to the one or more possible actions.
